(19) United States
(12) Patent Application Publication
(10) Pub. No.: US 2007/0131599 A1
(43) Pub. Date: Jun. 14, 2007

(54) METHOD FOR CHANNELING DEBRIS IN A POOL

(75) Inventor: John M. Goettl, Phoenix, AZ (US)

Correspondence Address: C. ROBERT VON HELLENS;CAHILL, VON HELLENS & GLAZER P.L.C., 155 PARK ONE,, 2141 E. HIGHLAND AVENUE, PHOENIX, AZ, 85016, US

(73) Assignee: Paramount Leisure Industries, Inc., Chandler, AZ (US)

(21) Appl. No.: 11/675,235

(22) Filed: Feb. 15, 2007

Related U.S. Application Data
(63) Continuation-in-part of application No. 10/392,606, filed on Mar. 19, 2003, now abandoned.

(51) Int. Cl. C02F 1/00

(52) U.S. Cl. 210/167.18

(57) ABSTRACT

A plurality of incrementally rotating nozzles are mounted in the bottom and side walls of a swimming pool to provide bursts of water and channel in a cascade manner debris toward one or more outlets disposed in the bottom of the pool.

### CROSS REFERENCE AND RELATED APPLICATION

The present application is a continuation-in-part application disclosing subject matter common with and claiming priority to an application entitled “Method And Apparatus For Channeling Debris In A Swimming Pool” filed Mar. 19, 2003 and assigned Ser. No. 10/392,606 and describing an invention made by the present inventor.

### BACKGROUND OF THE INVENTION

Because the desire to maintain a swimming pool clean and crystal clear has been with us for decades, various devices and methods have been developed in an attempt to obtain these results. These devices and methodologies attempt to direct debris in a swimming pool toward an outlet in communication with a filtration system that returns the pool water after the debris has been removed by filtration. Early on, such apparatus included a plurality of “whips” extending from various locations in the side walls which ejected water. The act of ejection caused the whips to move about in an essentially random fashion. The resulting randomly directed outflow of water tended to perform a washing action against the bottom surface and side walls to cause the debris to become suspended in the pool water and to move other debris along the respective surface. Given enough time, the suspended debris ultimately flowed into an outlet and thereby was removed from the pool. One of the main problems with such whips is that sections of the side walls and bottom surface tended to be undisturbed by a flow of water from the whips and debris would collect in these sections. This was a particular problem with debris too dense to remain suspended in the pool water. Further, because of the randomness of the movement of the debris, the debris removal process was slow and often incapable of removing debris as fast as it collected in the pool.

In an attempt to overcome the deficiencies of the whips, nozzles of various types were located in the side walls and bottom surface of the pool for ejecting a flow of water against the respective side walls and bottom surface. These multiple water flows had the effect of stirring the debris to attempt to entrain or suspend it in the swimming pool water for ultimate transport to an outlet. Debris that was not readily suspended would tend to collect on surfaces that had no or a low flow rate of water passing there across. Because the purpose of the nozzles was primarily that of randomly stirring the debris, the outflows of adjacent nozzles tended to be toward one another part of the time. Such counterflow caused only a partially effective result of channeling the debris toward and into an outlet.

Because of the ongoing interest of keeping swimming pools clean, various inventions have been conceived and disclosed in a number of United States patents, as set forth below. U.S. Pat. No. 3,045,829 (Rule, et al.) describes a plurality of nozzles mounted in the bottom of a swimming pool to provide an outflow to an outlet or drain. Further nozzles are located in the side walls to provide lateral and downward water flow. All of these nozzles provide water flow simultaneously which requires a relatively massive motor for driving a pump having a sufficient water flow rate to be effective. The costs of such a motor and pump, as well as the cost of the electric power to operate the motor renders this system completely impractical. U.S. Pat. No. 3,506,489 (Baker) describes a plurality of bottom and side wall mounted nozzles in a swimming pool which are sequentially operated. The nozzles may be of the rotating type that tend to move debris back and forth between areas washed by adjacent nozzles. The net effect is, at best, that of maintaining fine debris in the form of silt suspended but there is no teaching of channeling the non suspended debris to an outlet. U.S. Pat. No. 3,521,304 (Ghiz) describes a plurality of rotating nozzles from a single unit for directing flows of water along the adjacent pool surface and also upwardly away from the surface in an attempt to maintain debris suspended. Because of the rotating nature of the nozzles, the flow of water and any entrained debris is cause to flow not only toward an outlet but also away from the outlet. Thus, the effectiveness of expunging the debris from the pool is severely compromised. U.S. Pat. No. 3,449,772 (Werner) discloses a plurality of sequentially operating nozzles for the purpose of sweeping debris. Because of the rotating feature of the nozzles, any debris or sediment is directed not only toward the outlet but also away from the outlet and onto areas affected by adjacent nozzles. U.S. Pat. No. 3,247,969 (Miller) is directed to apparatus for introducing filtered water to a pool through bottom surface mounted nozzles in an effort to move sediment along the bottom surface and away from the nozzle. U.S. Pat. No. 4,114,206 (Franc) is directed to a pool cleaning system having a plurality of nozzles mounted in the side walls of a pool to direct water and debris to a specific locale. The nozzles are initial adjustable to direct a stream of water in a desired direction but are fixed thereafter and during operation of the cleaning system. As a practical matter, the pool cleaning system disclosed in the Franc patent is limited to relatively small backyard pools. U.S. Pat. No. 5,135,579 (Goettl) describes an invention made by the present inventor. This patent illustrates nozzles located on opposed side walls and on the bottom for directing a flow of water downwardly along the side walls and across the bottom to an outlet.

### BRIEF SUMMARY OF THE INVENTION

Water is discharged through a plurality of incrementally rotatable nozzles actuated in a predetermined sequence Through a predetermined arc as a function of the location of each nozzle to channel in a cascade manner debris along the surfaces of the bottom and side walls of a swimming pool to one or more outlets or drains. Depending upon placement in either the bottom or side walls of a swimming pool, the nozzles sequentially step through 90 degrees (90°), 180 degrees (180°), 360 degrees (360°) or an other angle; that is, the extent of rotation is a function of the location of each nozzle and the nature of the downstream surface extending toward the existing outlet(s) or drain(s). The arc of nozzles incrementally rotating through less than 360 degrees (360°) may be centered upon or at least directed toward the outlet(s) or drain(s). By sequentially operating the nozzles relative to one another, debris is directed from the surface area under the influence of one nozzle to a downstream surface area under the influence of a successively actuated nozzle in a cascade manner until the debris is ultimately channeled to an outlet or drain.

It is therefore a primary object of the present invention to locate selectively actuatable partially and fully incrementally rotatable nozzles in the bottom and side walls of a swimming pool to channel debris in a cascade manner toward and into an outlet.

Another object of the present invention is to provide partially and fully incrementally rotatable nozzles disposed in the bottom and side walls of a swimming pool for channeling debris in a cascade manner to an outlet.

Still another object of the present invention is to provide partially and fully incrementally rotatable nozzles disposed in the bottom and side walls of a swimming pool ejecting water in bursts lasting in the range of about thirty (30) seconds to about one (1) minute to channel debris in a cascading manner to an outlet.

Yet another object of the present invention is to provide nozzles in the bottom surface and side walls of a swimming pool which incrementally rotate through a predetermined angle as a function of their location to augment and maintain movement of debris toward an outlet in a swimming pool.

A further object of the present invention is to provide a method for cleaning a swimming pool by channeling debris toward an outlet in response to sequential water flows from discretely located nozzles, some of which nozzles may be incrementally partially rotatable while others may be incrementally fully rotatable.

A still further object of the present invention is to provide a method for incorporating selectively actuated nozzles rotatable through a predetermined number of degrees as a function of the location of the nozzle and the adjacent surface of a swimming pool to channel debris toward an outlet.

A yet further object of the present invention is to provide a swimming pool with a plurality of incrementally rotatable nozzles for channeling debris along the surfaces of the bottom and side walls of a swimming pool to an outlet.

These and other objects of the present invention will become apparent to those skilled in the art as the description there proceeds.

### BRIEF DESCRIPTION OF THE DRAWINGS

The present invention will be described with greater specificity and clarity with reference to the following drawings, in which:

FIGS. 1 and 2 illustrate perspective and cross sectional views, respectively, of a conventional pool having conventional 360 degree (360°) rotatable nozzles mounted in the bottom surface and downwardly directed nozzles in the side walls;

FIGS. 3 and 4 illustrate a perspective view and a cross sectional view, respectively, of a swimming pool having an arrangement of incrementally rotating nozzles operating in the manner of the present invention;

FIGS. 5 and 6 illustrate a perspective view and a cross sectional view, respectively, of a swimming pool having a variant arrangement of incrementally rotating nozzles functioning to channel debris to an outlet;

FIGS. 7 and 8 illustrate a perspective view and a cross sectional view, respectively, of a plurality of selectively actuated incrementally rotating nozzles operating to channel debris into either of two outlets;

FIG. 9 illustrates a perspective view of a swimming pool similar to the pool shown in FIGS. 7 and 8 but having a single outlet located in a corner at the deep end with nozzles incrementally rotating through less than three hundred sixty degrees (360°) in the side walls to develop a debris collection zone about the outlet;

FIG. 10 illustrates selectively actuatable incrementally rotating nozzles for creating a collection zone to collect debris about an outlet located centrally at the deep end; and

FIGS. 11 and 12 illustrate a perspective view and a cross sectional view, respectively, of a vinyl lined pool having a hopper section and selectively actuated incrementally rotating nozzles for directing debris to a pair of outlets.

### DESCRIPTION OF THE INVENTION

Debris in a pool is primarily of three types. The first type includes very fine clay and fine vegetative matter that can be maintained in suspension for eventual removal by a filtration system of a swimming pool. The second type includes heavy debris, such as sand, leaves, gravel and the like, which essentially is not suspendable and must be moved to a collection zone where it can be withdrawn from the swimming pool through an outlet or drain adapted for this purpose. The third type includes debris too large to pass through the outlet and must be withdrawn by other means. The present invention is primarily directed to removal of the second type of debris although it will have a beneficial effect of directing the other types of debris toward the outlet or drain.

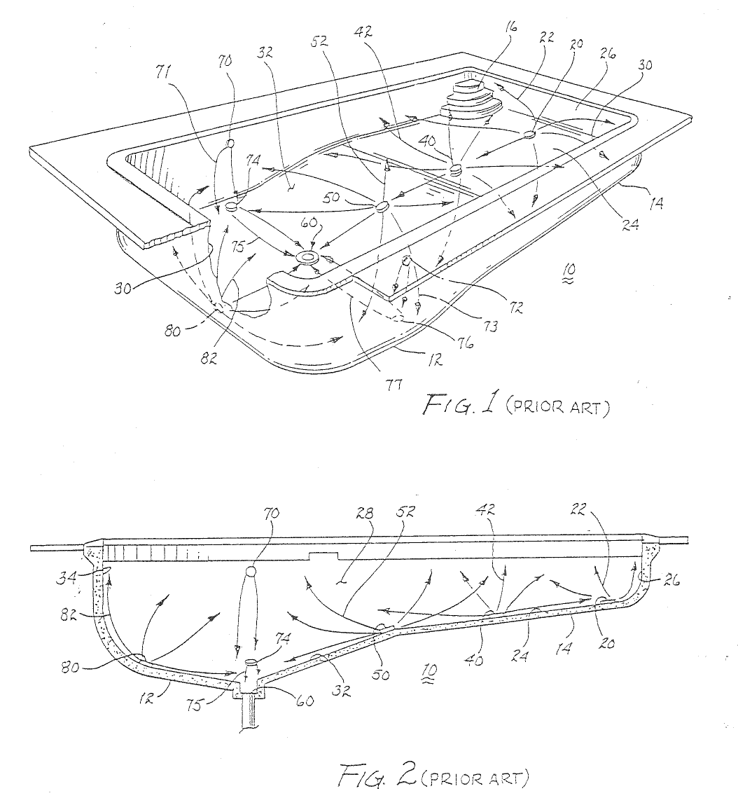

Referring jointly to FIGS. 1 and 2, there is illustrated a conventional swimming pool 10 having a deep end 12 and a shallow end 14 embodying prior art methodology. As illustrated, one of the corners at the shallow end includes steps 16. Generally, one or more nozzles 20 disposed close to the extremity of the shallow end rotates 360 degrees (360°) incrementally in a step manner to discharge a burst of water at each incremental position. As illustrated by arrows 22 emanating from nozzle 20, each burst of water performs a washing or scrubbing action along each path of water flow. The plurality of paths jointly direct water away from the nozzle along bottom surface 24, end surface 26 and each of side walls 28, 30. Moreover, one or more bursts of water will tend to wash/scrub the surfaces of steps 16 with greater or lesser degree of success. The effect of nozzle 20 is primarily that of attempting to suspend debris in the pool water and it may have a secondary effect of directing debris lying on the bottom surface and side walls away from the nozzle.

Generally, one or more further nozzles 40 is located a distance toward deep end 12 from nozzle 20. This further nozzle(s) rotates 360 degrees (360°) in a step manner like nozzle 20 and directs sequential bursts of water in a successive omni directional manner, as represented by arrows 42. As it becomes quickly evident by inspection, the bursts of water directed toward shallow end 14 will interfere with and counter, to a greater or lesser extent, the bursts of water emanating from nozzle 20 toward deep end 12. Thereby, any suspended debris or debris on the surfaces initially directed toward the deep end by nozzle 20 may be halted and directed toward the shallow end or toward either of the side walls of the pool by nozzle(s) 40. A certain number of the bursts of water emanating from nozzle(s) 40 and conveying debris will be directed toward deep end 12. By inspection, it becomes evident that the opposing bursts of water flow between nozzles 20 and 40 are generally counter productive in channeling debris in an organized manner in a predetermined common direction.

Generally, a further nozzle 50 or a set of nozzles is disposed in the steep inclined section 32 of the pool bottom surface. Nozzle(s) 50 is similar to nozzles 20, 40 and provide incremental bursts of water in a sequential rotation pattern extending through 360 degrees (360°). Again, certain of the bursts of water from nozzle(s) 50, as depicted by arrows 52, are directed toward the shallow end and oppose or otherwise counteract the beneficial bursts of water flow from nozzle(s) 40 toward the deep end. Thereby, debris initially directed toward the deep end by nozzle(s) 40 may be halted or urged laterally toward the side walls of the pool or toward the shallow end. Certain of the bursts of water from nozzle(s) 50 will urge bursts of water toward outlet 60 and convey debris to the outlet. Some debris on the bottom surface of the pool will be encouraged to roll or slide downwardly along the inclined section 32 toward outlet 60. Nevertheless, the bursts of water from nozzles 50 and 40 toward one another will be counterproductive in channeling debris toward the outlet.

To assist in channeling debris toward outlet 60, a pair of nozzles 70, 72 are disposed on opposed side walls of pool 10 and may direct a steady flow of water downwardly, as represented by arrows 71, 73, respectively. A further pair of nozzles 74, 76 are located proximate the junction of the side walls and the bottom surface of the pool. These nozzles provide a steady flow of water toward outlet 60 as represented by arrows 75, 77, respectively. Thereby, the downward flow of debris proximate nozzles 70, 72 is continued by the steady flow of water from nozzles 74, 76, respectively, until the debris is ultimately conveyed to outlet 60. It may be appreciated that any debris conveyed by the bursts of water from nozzle(s) 50 into functional engagement with the flows of water from nozzles 74, 76 will be encouraged to migrate toward outlet 60. This apparatus and methodology are described with greater specificity in U.S. Pat. No. 5,135,579 (Goettl), which patent is owned by the present assignee and incorporated herein by reference.

Generally, a nozzle 80 (or a plurality of nozzles 80) is disposed proximate the junction of the bottom surface of swimming pool 10 and end wall 34 at deep end 12. This nozzle(s) provides sequential bursts of water incrementing through 360 degrees (360°) to scrub/wash a circular pattern about nozzle 80. As represented by arrows 82, only some of the bursts of flow of water will convey debris toward outlet 60. Furthermore, certain of these bursts of water will countermand the effects of debris containing water flows from nozzles 70, 72, 74, 76 and possibly even from nozzle(s) 50.

In conclusion, prior art nozzles in pools tend to stir up debris to place it in suspension to the extent it is suspendable with the apparent hope that ultimately the suspended debris will migrate toward an outlet and finally be removed by the filtration system attendant the swimming pool. As is clearly represented in FIGS. 1 and 2, the flow paths presented by the prior art are inefficient. Particularly, there is no concerted effort nor capability of channeling debris to an outlet either directly and in a cascade manner.

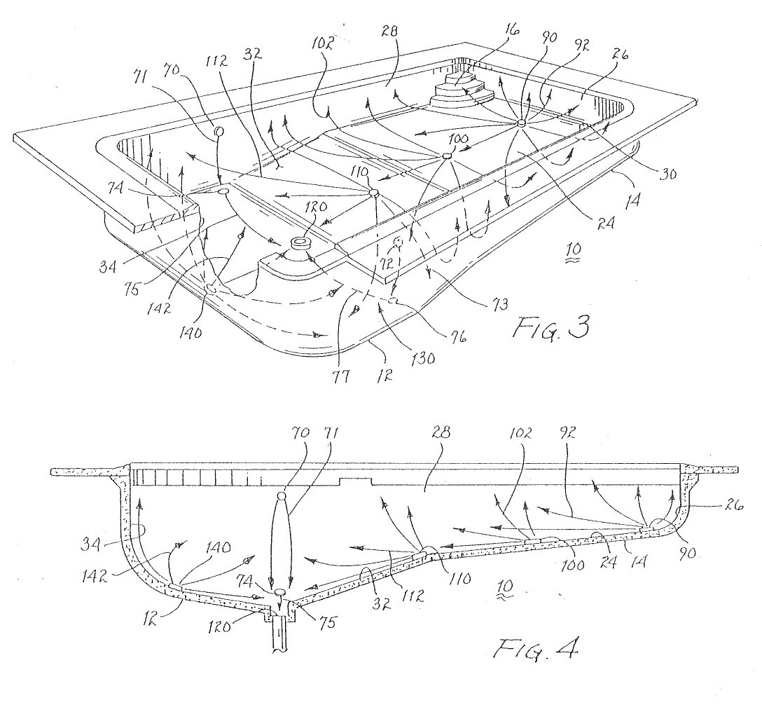

Referring jointly to FIGS. 3 and 4 there is illustrated a pool similar in type to that shown in FIGS. 1 and 2; however, the system of incrementally rotating nozzles disposed therein provides an effect and a result completely different from the pool cleaning system illustrated and described with respect to FIGS. 1 and 2. By use of the phrase “incrementally rotating nozzle” reference is made for example to the type of nozzle described in U.S. Pat. No. 6,848,124 (Goettl) which patent is incorporated herein by reference. This nozzle includes a cam ring disposed about in erectable nozzle housing and a pin extending from the nozzle housing engages a saw tooth member of the cam ring. Each time water flows into the nozzle assembly, the nozzle housing rises and is incrementally rotated by cooperation of the pin with a saw tooth member and water will be ejected from the nozzle housing along a corresponding orientation while the nozzle housing is in the erect state. Upon cessation of water flow to the nozzle assembly, the nozzle housing will retract. Upon retraction, the pin will engage a further saw tooth member and result in a simultaneous incremental rotation of the nozzle housing. Upon subsequent flow of water into the nozzle assembly, erection of the nozzle housing and further incremental rotation of the nozzle housing will occur. The nozzle housing will continue to rotate incrementally with each erection and retraction until a cam reverser is engaged. Upon such engagement, the cam ring will be incrementally angularly repositioned and the nozzle housing will be incrementally rotated in the opposite direction until the cam reverser again is engaged to reposition the cam ring and causes a change in direction of rotation. It is evident that the configuration of the cam reverser can be and is used to regulate the angle through which the nozzle housing rotates.

A further example of an “incrementally rotating nozzle” is disclosed in U.S. Pat. No. 6,899,285 (Goettl, et al.), which patent is incorporated herein by reference. Herein, a cam and pin mechanism is also used to cause incremental rotation of a nozzle housing each time the nozzle housing cycles through an erection/retraction sequence. Another type of “incrementally rotating nozzle” is described in U.S. Pat. No. 5,251,343 (Goettl) and incorporated by reference herein.

In conclusion, the term “incrementally rotating nozzle” and variants thereof, refer to a nozzle that ejects a stream of water each time the nozzle is erected from a nozzle assembly due to flow of water into the nozzle assembly. Upon cessation of water flow into the nozzle housing, the nozzle will retract into the nozzle assembly. Upon subsequent erection of the nozzle the stream of water flowing therefrom will be along a different angular orientation. As described for example in U.S. Pat. No. 6,848,124 (Goettl), the angular range through which the nozzle can incrementally rotate can be predetermined by the configuration of the cam reverser. For example, the angular range could be about ninety degrees (90°) or about one hundred and eighty degrees (180°). Or, the angular range may be of any angle up to a full circle (360°).

As shown in FIGS. 3 and 4, one or more incrementally rotating nozzles 90 are disposed in bottom surface 24 close to end wall 26 at the shallow end of the pool. Nozzle(s) 90 incrementally rotate 360 degrees (360°) to provide bursts of water at successive angular orientations, as reflected by arrows 92. The bursts of water generally directed toward end wall 26 will tend to wash/scrub the intervening bottom surface and the end wall. Furthermore, these bursts of water will cause the water to flow laterally along the end wall to the corresponding side walls 28, 30 and transport debris therewith. Steps 16 will be similarly periodically scrubbed/washed to remove debris thereon or place the debris in suspension proximate thereto. The sequential bursts of water (arrows 92) directed laterally toward end walls 28, 30 will tend to mix with water flows along the respective side wall caused by bursts of water deflected laterally upon striking end wall 26. Thus, these flows of water directed generally toward deep end 12 will be augmented by other bursts of water flow from nozzles to be described to continue to transport debris therewith. The bursts of water directly or generally toward the deep end will tend to channel debris there along.

One or more nozzle(s) 100 is an incrementally rotating nozzle rotating through a range of approximately 180 degrees (180°) or somewhat less. All bursts of water from nozzle(s) 100, as depicted by arrows 102, will be either laterally or more or less in a direction toward the deep end. Even though the flow may be toward a wall, the angle of deflection at the wall will cause debris to move along the wall toward the deep end. Because of the orientation of the bursts of water from nozzle(s) 100, nozzle(s) 100 is precluded from conveying debris toward nozzle(s) 90 and toward the shallow end. Thus, any debris conveyed toward the deep end as a result of bursts of water (arrows 92) from nozzle(s) 90 will be enhanced and augmented by the flows of water from nozzle(s) 100. Thereby, the debris is channeled toward the deep end, first by nozzle(s) 90 and then by nozzle(s) 100.

One or more further nozzle(s) 110 disposed in inclined section 32 is a nozzle(s) incrementally rotating through 180 degrees (180°) or somewhat less. As depicted by arrows 112, the incremental bursts of water from nozzle(s) 110 will direct the water and any debris laterally toward side walls 28, 30 but primarily downwardly along inclined section 32 and toward the deep end. Because of the orientation of the bursts of water from nozzle(s) 110, nozzle(s) 110 is precluded from conveying debris toward nozzle(s) 100 and toward the shallow end. The debris caused to be conveyed toward the deep end by bursts of water from nozzle(s) 100 will become entrained with the bursts of water from nozzle(s) 110 and the conveyance of the debris will be augmented by nozzle(s) 110. This results in a channeling of the debris toward a collection zone created primarily by nozzles 70, 72, 74 and 76 proximate outlet 120 at the deep end.

Nozzles 70, 72 in side walls 28, 30 and nozzles 74, 76 therebeneath and essentially on opposed sides of outlet 120 are part of a collection zone described in detail in U.S. Pat. No. 5,135,579 and comprises an invention by the present inventor. This cleaning system, in essence, causes any debris flowing along the side walls or along the bottom into proximity with and under the influence of the water flowing from nozzles 70, 72, 74 and 76 and then becomes channeled toward a collection zone attendant outlet 120. Thereby, any suspended debris flowing along side walls 28, 30, as well as any debris flowing along bottom surface 24 and inclined surface 32 will become subjected to the influence of the cleaning system and be channeled toward a collection zone created primarily by nozzles 70, 72, 74 and 76 proximate outlet 120 and into the outlet.

One or more further incrementally rotating nozzle(s) 140 may be disposed proximate the junction of bottom surface 24 and end wall 34 at deep end 12. Nozzle(s) 140 incrementally rotates on steps through 360 degrees (360°) to provide bursts of water successively angularly displaced, as represented by arrow 142, to wash/scrub the adjacent pool surfaces. Any debris placed in suspension or caused to slide along the side wall surfaces will come under the influence of the bursts of water from nozzle(s) 140 and tend to be transported laterally. In which event, the debris will come under the influence of the cleaning system (nozzles 70, 72, 74 and 76) and be channeled toward a collection zone proximate outlet 120 or be transported downwardly either directly toward outlet 120 or angularly displaced therefrom but ultimately coming under the influence of the flows of water from nozzles 74, 76.

To be effective to establish a water flow along a surface, a burst of water from each incremental position of a nozzle should continue for a period in the range of about thirty (30) seconds to about one (1) minute. Thus, the nozzles described with reference to FIGS. 3 and 4 and the nozzles to be described with respect to the remaining figures would have bursts of water having a duration in this range. The nozzles described with respect to FIGS. 3 and 4 and to be described with reference to the remaining figures may be described as incrementally rotating through an angle of about 90 degrees (90°), about 180 degrees (180°) or 360 degrees or less (360°). However, depending upon the location of the nozzle(s) and the nature and orientation of the adjacent pool surfaces, the degree of incremental rotation may be through any angle between zero degrees (0°) and 360 degrees (360°).

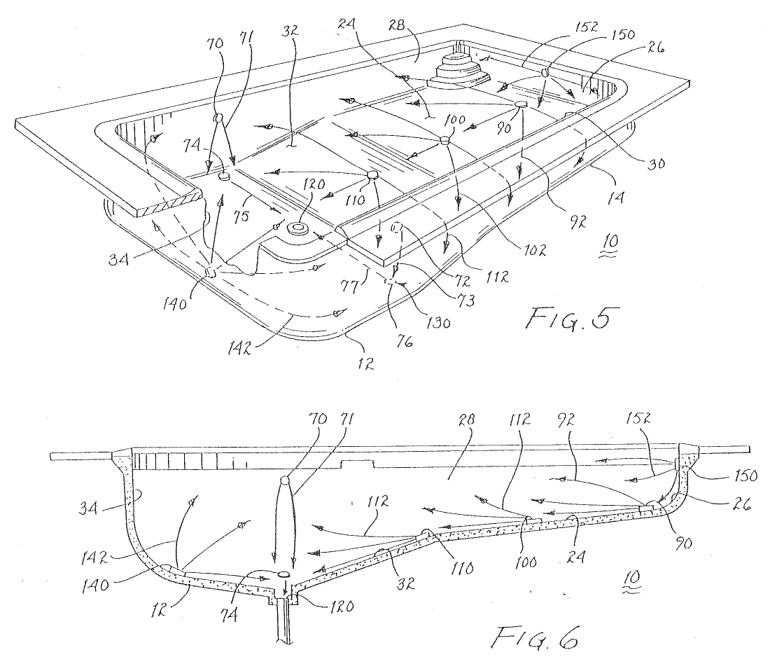

FIGS. 5 and 6 illustrate a variant of the system of nozzles described with respect to FIGS. 3 and 4. Herein, one or more incrementally rotating nozzle(s) 150 is disposed in end wall 26. This nozzle sequentially provides bursts of water at each of different angular orientations, as represented by arrows 152, extending through an arc of about 180 degrees (180°) with the diametrically opposing flows from bursts of water being located close to the surface of the water. The resulting washing action will tend to wash end wall 26 and direct/convey debris therefrom. Any debris dislodged from the end wall and sections of side walls 28, 30 proximate end wall 26 will be conveyed generally toward deep end 12. Similarly, any debris on bottom surface 24 proximate the end wall will be directed along the bottom surface generally toward the deep end. Nozzle(s) 90 (as described above) is located downstream of nozzle(s) 150 and provides bursts of water through an arc of about 180 degrees (180°) oriented away from end wall 26. Because of the orientation of the bursts of water from nozzle(s) 80, nozzle(s) 90 are precluded from conveying debris toward nozzle(s) 150 and toward the shallow end. Any debris urged toward the deep end by the bursts of water from nozzle(s) 150 will become entrained with the bursts of water from nozzle(s) 90 and will be further conveyed toward the deep end. Thereby, nozzle(s) 150 channels water from the shallow end to mix with the flows of water in the direction of the deep end and emanating from the next downstream nozzle(s). Further incrementally rotating nozzle(s) 100 perform similarly to nozzle(s) 90 and pick up debris channeled thereto by the bursts of water from upstream 180 degree (180°) nozzle(s) 90. The bursts of water from remaining incrementally rotating nozzle(s) 110 will convey debris channeled by nozzle(s) 100 toward the deep end and into influence of the collection zone formed by nozzles 70, 72, 74 and 76, as described above. Incrementally rotating nozzle(s) 140 are disposed at the lower end of end wall 34 and provide bursts of water at different angular orientations, as represented by arrows 142, to convey debris laterally into influence of the cleaning system of nozzles 70, 72, 74 and 76 and to convey debris toward a collection zone in proximity with outlet 120. Because of the conventional steepness of the slope of end wall 34 little, if any, debris will rest thereon and scrubbing of this area may not be necessary. However, it is to be understood that an incrementally rotating nozzle, such as nozzle 150 at the shallow end, could be placed in wall 34 to scrub the wall and convey debris downwardly toward nozzle 140.

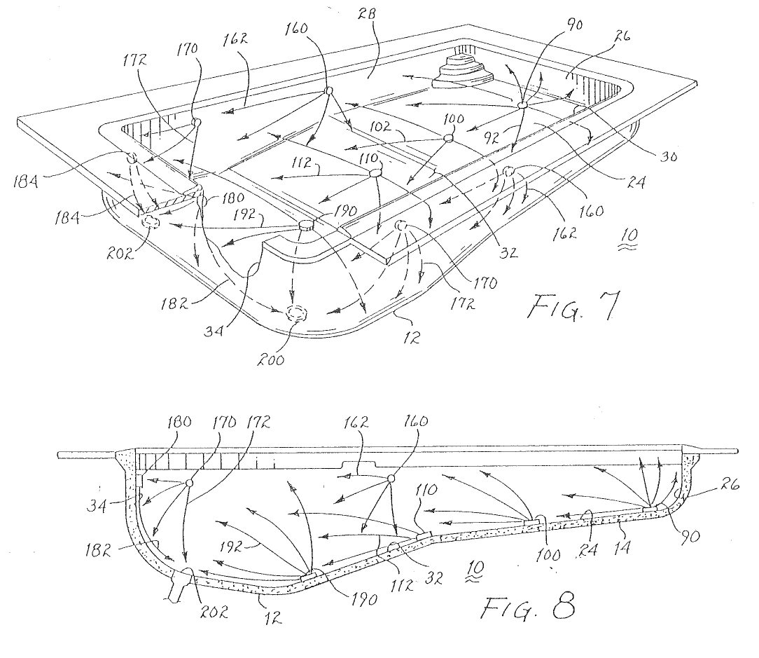

Referring to FIGS. 7 and 8, there is illustrated a yet further variant of the pool shown in FIGS. 3 and 4. Herein, additional side wall nozzles are employed to channel water, debris and suspended debris laterally along the side walls and downwardly as well as toward the bottom surface. In particular, opposed pair of incrementally rotating nozzles 160 provide sequential angularly displaced bursts of water, represented by arrows 162, through an arc of about 90 degrees (90°) extending from an orientation essentially parallel to and along the top surface of the pool water to an orientation essentially vertically downwardly toward the bottom surface. Thereby, nozzles 160 channel any debris flowing along the side walls of the pool toward the deep end and toward the bottom surface. A yet further pair of incrementally rotating nozzles 170 may be disposed in the respective side walls to provide bursts of water, represented by arrows 172, through an arc of about 90 degrees (90°). These bursts of water continue the flow of debris conveyed by nozzles 160 along the bottom surface and laterally along the side walls toward the deep end.

An incrementally rotating nozzle 180 is disposed in end wall 34 at deep end 12 to provide sequential angularly displaced bursts of water, represented by arrows 182, through an arc of about 180 degrees (180°) extending from diametrically opposed directions approximately along the top surface of the pool water to a vertical flow downwardly toward the bottom surface. To augment the flow along end wall 34, additional incrementally rotating nozzles 184 providing sequentially displaced bursts of water through an arc of about 90 degrees (90°) may be disposed in side walls 28, 30. For example, these nozzles could be about 90 degree (90°) or about 45 degree (45°) nozzles to provide sequential bursts of water downwardly and/or laterally through an arc of about 90 degrees (90°) or about 45 degrees (45°), respectively, as represented by arrows 186. Yet further incrementally rotating nozzle(s) 190 providing sequentially displaced bursts of water through an arc of about 180 degrees (180°) may be located at the deep end to channel water and debris laterally in opposed directions and toward the end wall at the deep end, as represented by arrows 192. This nozzle(s) assists in channeling any debris conveyed toward the deep end by upstream nozzles, such as nozzles 110, 100. In the embodiment shown in FIGS. 7 and 8, a pair of outlets 200, 202, representing collection zones, are disposed proximate the corners of the pool in the deep end. Herein, the two collection zones attendant outlets 200, 202 would be generally at the conflux of the end wall, the bottom and the respective side walls and created by adjacent nozzles 180, 190 and 170 and by adjacent nozzles 180, 184 and 170, respectively.

In summary, debris is channeled along the side walls both laterally and downwardly toward the deep end in a cascade manner to continually augment and enforce the flow of the debris produced by upstream nozzles to a collection zone attendant each of outlets 200, 202 until the debris ultimately flows into one or the other of outlets 200, 202.

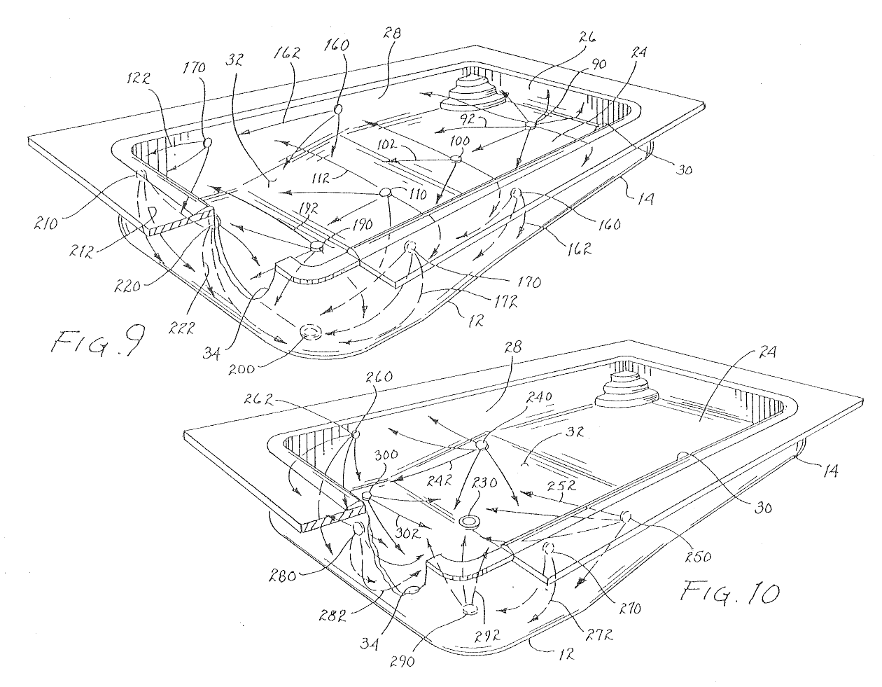

FIG. 9 illustrates a further embodiments similar to that shown in FIGS. 7 and 8 except that deep end 12 includes a single outlet 200 disposed proximate one comer of the deep end. Furthermore, each of a pair of incrementally rotating nozzles 210, 220 provide sequentially displaced bursts of water through an arc of about 90 degrees (90°) to channel water laterally and downwardly along the surface of end wall 34, as represented by arrows 212, 222, respectively, to encourage lateral and downward flow of the debris toward a collection zone proximate outlet 200. The flow from nozzles 210, 220 will tend to augment the flows of debris caused by nozzles 170, 190 toward outlet 200, as well as the flows of debris caused by nozzles 160, and 110.

Referring to FIG. 10 there is shown a particularly suitable arrangement for forcing the debris attendant the end wall and side walls close to the deep end, the debris along the bottom surface of the deep end and the debris along inclined section 32 into a collection zone and toward a generally centrally located outlet 230. Herein, a pair of nozzles 240, 250, each incrementally rotating through an arc of about 90 degrees (90°), cause sequential angularly displaced bursts of water, represented by arrows 242, 252, respectively, along the bottom surface in the general direction of outlet 230 and along the respective side walls. Nozzles 260, 270, incrementally rotating through an arc of about 90 degrees (90°), are disposed proximate the water surface in side walls 28, 30 to urge water flow, represented by arrows 262, 272, respectively, along the side walls toward the end wall and downwardly toward the bottom surface. The flow of water and debris along the side walls and the end wall are encouraged to flow downwardly, represented by arrows 282, by nozzle 280 located generally centrally of the end wall, which nozzle incrementally rotates through an arc of approximately 180 degrees (180°). Each pair of 90 degree (90°) nozzles 290, 300 disposed at the bottom corners of the deep end incrementally rotate through an arc of about 90 degrees (90°) to provide sequential angularly displaced bursts of water through an arc of about 90 degrees (90°) generally toward outlet 230, as represented by arrows 292, 302, respectively. These bursts of water convey and channel water and debris from the outflows of adjacent upstream nozzles toward outlet 230.

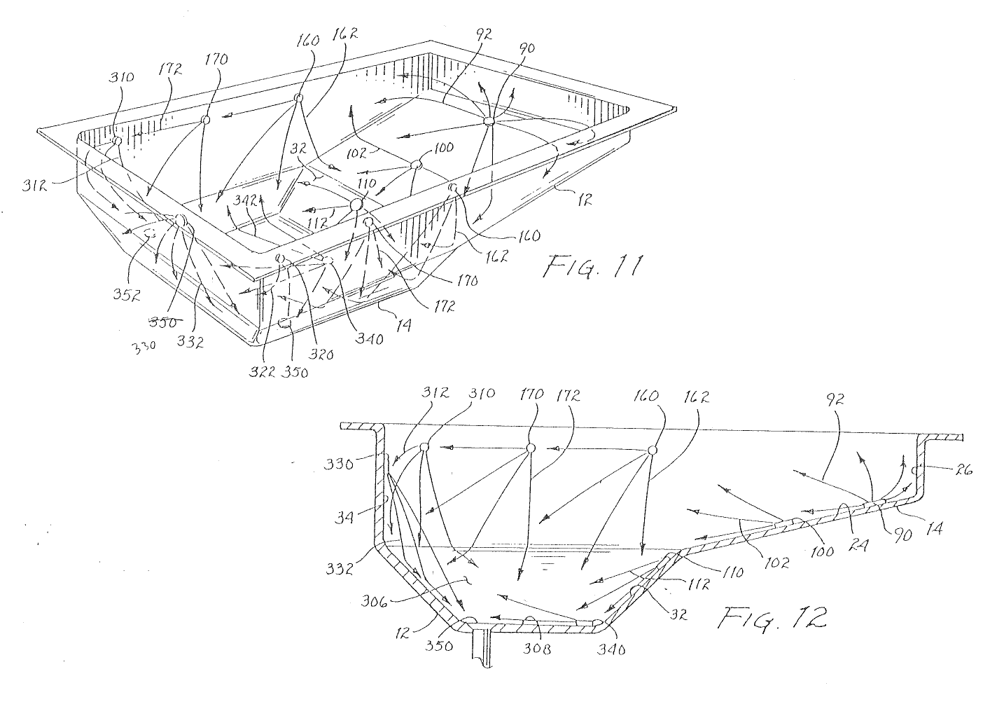

FIGS. 11 and 12 illustrate a perspective and a cross sectional view, respectively, of a vinyl lined pool which is often used in climates wherein the water in a swimming pool will freeze in the winter time. These pools are generally formed by excavations into the ground, which excavations are lined with a plastic liner, such as vinyl. Because of construction requirements of such a liner, the pool includes a hopper section 306 generally corresponding with the deep end (12) of a conventional pool. For greatest efficiency and expunction of debris from the side walls, end walls and bottom surfaces of the liner, an arrangement of nozzles similar to that shown in FIG. 9 is employed. Accordingly, common elements will be identified with common numerals. However, additional side wall mounted nozzles 310, 320 incrementally rotating through an arc of about 90 degrees (90°) may be employed to encourage flow of debris, represented by arrows 312, 322, respectively, past the corner between side walls 28, 30 and end wall 34 at deep end 12. Such flows generally extend through an arc of about 90 degrees (90°) from a direction generally parallel and close to the surface of the water to an essentially downward vertical direction. Nozzle 330, which may be a nozzle incrementally rotating through an arc of about 90 degrees (90°) or about 180 degrees (180°) may be disposed in end wall 34 close to the top surface of the water to cause debris to flow downwardly and laterally, as represented by arrows 332. A further incrementally rotating nozzle 340 may be disposed at bottom 308 of hopper section 306 to prevent collection of debris at the angular junction between downwardly inclined surface 32 of the hopper section and the generally flat portion at the bottom. That is, nozzle(s) 340 would provide sequential bursts of water (arrows 342) through an arc to be determined to augment and carry forward the flow of water and debris emanating from the nozzles (110) disposed on the inclined surfaces. The outlet may include a single outlet 350 and a second outlet 352, each of which may be disposed in essentially flat bottom 308 close to the side walls and the inclined surface extending from the vertical end wall at the deep end. Herein, the collection zone may be considered the bottom area of the hopper in combination with sloping end wall 12.

In summary, each of the embodiments illustrated provides a plurality of incrementally rotating nozzles providing sequential bursts of water through an arc of up to 360 degrees (360°), depending upon the location of each of the nozzles. The streams of water from each of the nozzles are precluded from flowing counter to the streams of water from adjacently located nozzles. Thereby, the totality of nozzles provide a continuing flow of water and debris along the submerged surfaces of the pool ultimately terminating at a respective outlet. Such continuity of flow will have the effect of channeling, conveying, and/or transporting debris therewith much more efficiently than the prior art teachings and few, if any, dead spots without flow of water will exist. It is particularly to be noted that the bursts of water from any nozzle are precluded from impeding or otherwise countering the flow(s) from any other nozzle(s). Thus, a flow initiated by one nozzle is continued by a downstream subsequent nozzle until the flow ultimately is exhausted through an outlet and the debris is conveyed therewith.

I claim:

1. A method for removing debris from a swimming pool having surfaces defining a first end, a second end, side walls, a bottom, and including incrementally rotating nozzles for providing bursts of water along a surface at each incremental position of each nozzle and a collection zone proximate a discharge outlet for the water, said method comprising the steps of:
a) discharging water through at least one incrementally rotating nozzle disposed proximate the first end to direct bursts of water sequentially through a predetermined arc and any conveyed debris along surfaces of the first end;
b) further discharging water through at least one incrementally rotating further nozzle rotating through an arc of less than 360 degrees (360°) disposed between the at least one nozzle and the collection zone to direct bursts of water sequentially through a predetermined arc and any conveyed debris along the surfaces of the bottom toward the collection zone and to augment the flow of water and conveyed debris from the at least one nozzle, each of the further nozzles being precluded from directing bursts of water toward the first end; and
c) yet further discharging water into the swimming pool through at least one incrementally rotating yet further nozzle disposed proximate the second end to direct bursts of water sequentially through a predetermined arc and any conveyed debris along the surfaces of the second end toward the collection zone.

2. The method as set forth in claim 1 including the step of directing bursts of water sequentially through a predetermined arc from at least one side wall mounted incrementally rotating nozzle and from at least one further side wall mounted incrementally rotating nozzle along the respective side walls and toward the collection zone.

3. The method as set forth in claim 1 including the step of still further discharging water into the swimming pool through at least one incrementally rotating still further nozzle disposed between the at least one further nozzle and the collection zone to direct bursts of water sequentially through a predetermined angle and any conveyed debris toward the collection zone and to augment the flow of bursts of water and conveyed debris from the at least one further nozzle.

4. The method as set forth in claim 1 wherein said step of discharging directs a flow of bursts of water from the at least one nozzle rotating through an arc of 360 degrees (360°).

5. The method as set forth in claim 1 wherein said step of further discharging directs a flow of water from the at least one further nozzle incrementally rotating through an arc of about 180 degrees (180°) oriented away from the first end.

6. The method as set forth in claim 1 wherein said step of yet further discharging directs a flow of water from the at least one yet further nozzle rotating through an arc of about 180 degrees (180°) oriented away from the first end.

7. The method as set forth in claim 2 wherein said step of directing directs a flow of water from each of the at least one side wall nozzle and the at least one further side wall nozzle incrementally rotating through an arc of about 90 degrees (90°) oriented away from the first end.

8. The method as set forth in claim 4 wherein said steps of further discharging and yet further discharging directs a flow of water from each of the at least further and yet further nozzles rotating through an arc of about 180 degrees (180°).

9. The method as set forth in claim 8 including the steps of directing bursts of water sequentially through a predetermined arc from at least one side wall mounted incrementally rotating nozzle and from at least one further side wall mounted incrementally rotating nozzle along the respective side walls and toward the collection zone.

10. The method as set forth in claim 9 wherein said step of directing directs a flow of water from each of the at least one side wall nozzle and the at least one further side wall nozzle incrementally rotating through an arc of about 90 degrees (90°) oriented away from the first end.

11. The method as set forth in claim 1 including the step of directing bursts of water sequentially through a predetermined arc from an incrementally rotating at least one end wall nozzle disposed in one of the first and second end walls along the respective end wall and toward the bottom.

12. The method as set forth in claim 11 wherein said step of directing directs a flow of bursts of water through an arc of about 180 degrees (180°).

13. The method as set forth in claim 10 including the step of further directing bursts of water sequentially through a predetermined arc from an incrementally rotating at least one end wall nozzle disposed in one of the first and second end walls along the respective end wall and toward the bottom.

14. The method as set forth in claim 13 wherein said step of further directing directs a flow of water from the at least one end wall nozzle incrementally rotating through an arc of about 180 degrees (180°).

15. The method as set forth in claim 1 wherein said step of discharging directs a flow of bursts of water sequentially through a predetermined arc from the at least one nozzle rotating incrementally through an arc of about 180 degrees (180°).

16. The method as set forth in claim 11 including the step of further directing bursts of water sequentially through a predetermined arc from an incrementally rotating at least one further end wall nozzle disposed in the other of the first and second end walls along the respective end wall and toward the bottom.

17. The method as set forth in claim 16 wherein said step of further directing directs a flow of bursts of water from the at least one further end wall nozzle incrementally rotating through an arc of about 180 degrees (180°).

18. A method for removing debris from a swimming pool having surfaces defining a first end, a second end, side walls, a bottom, a quantity of water and at least one outlet for the water, said method comprising the steps of:
a) discharging bursts of water sequentially through a predetermined arc from an incrementally rotating nozzle along the bottom toward the second end and to convey any debris encountered, the nozzle being precluded from discharging bursts of water toward the first end;
b) further discharging sequential bursts of water proximate the first end through an incrementally rotating further nozzle along the bottom and through an arc encompassing the nozzle to convey any debris encountered and subject such debris to the influence of the bursts of water from the nozzle;
c) still further discharging sequential bursts of water proximate the second end through an incrementally rotating still further nozzle along the bottom and through an arc oriented toward the outlet and to convey to the outlet any debris encountered; and
d) yet further discharging sequential bursts of water through an incrementally rotating side wall nozzle disposed in one of the side walls and through an incrementally rotating further side wall nozzle disposed in the other of the side walls along the respective side walls through respective arcs oriented toward the second end to convey to the second end any debris encountered, the side wall nozzle and the further side wall nozzle being precluded from discharging bursts of water toward the first end.

19. The method as set forth in claim 18 including the step of directing sequential bursts of water through an incrementally rotating yet further nozzle disposed in one of the side walls along the respective side wall through an arc oriented toward the second end, the yet further nozzle being precluded from directing bursts of water toward the first end.

20. The method as set forth in claim 19 including the step of further directing sequential bursts of water through an incrementally rotating still further nozzle disposed in the other of the side walls along the respective side wall through an arc oriented toward the second end, the still further nozzle being precluded from directing bursts of water toward the first end.

21. A method for removing debris from a swimming pool including surfaces defining a shallow end, a deep end, side walls and a bottom, a plurality of incrementally rotating nozzles, each of the nozzles providing a burst of water along a surface at each incremental position and at least a collection zone proximate an outlet for discharging water and debris from the swimming pool, said method comprising the steps of:
a) discharging a stream of water from each incremental position of at least one incrementally rotating first nozzle located proximate the shallow end to direct sequential angularly displaced streams of water and any conveyed debris along the bottom surface and any side wall surfaces subjected to the streams of water, at least some of which streams of water are angularly oriented in a direction toward the collection zone.
b) further discharging a stream of water from each incremental position of at least one incrementally rotating second nozzle disposed in the swimming pool toward the collection zone from each of the second nozzles to direct angularly displaced streams of water and any conveyed debris along the bottom surface and any side wall surfaces subjected to the streams of water to augment in a cascade manner the flow of debris conveyed by the streams of water from the at least one first nozzle toward the collection zone, each of the second nozzles being precluded from directing any streams of water toward any one of the first nozzles to reduce the likelihood of any debris conveyed by the streams of water from the first and second nozzles being re-conveyed toward the shallow end.

22. A method for cascading the flow of debris in a swimming pool toward a collection zone located in proximity to the water drain of the pool by using a plurality of incrementally rotating nozzles to discharge sequentially angularly displaced streams of water, said method comprising the steps of:
a) discharging sequentially angularly displaced streams of water from at least one first nozzle along the bottom surface of the shallow end of the pool to urge conveyance of debris to an area of the pool under the influence of streams of water from at least one second nozzle;
b) further discharging sequentially angularly displaced streams of water from the at least one second nozzle generally directed toward the collection zone;
c) precluding discharge of the streams of water from the at least one second nozzle toward each of the at least one first nozzle;
d) said step of further discharging including the step of conveying toward the collection zone debris coming under the influence of the streams of water from the at least one second nozzle; and,
e) augmenting and continuing the conveyance to the collection zone of the debris transported by the streams of water from the at least one first nozzle into the area of influence of the streams of water from the at least one second nozzle;
whereby, the debris transported by the streams of water from the at least one first nozzle to an area under influence by the at least one second nozzle is urged toward the collection zone and the at least one second nozzle is precluded from urging any debris toward the at least one first nozzle.

23. A method for conveying in a cascading manner debris from the surfaces of a swimming pool to a collection zone proximate a drain, said method comprising the steps of:
a) ejecting sequential angularly displaced streams of water from an incrementally rotating first nozzle disposed in a first area of the swimming pool to convey debris away from the first nozzle, some of the streams of water being ejected to an area of the swimming pool under the influence of streams of water from a second incrementally rotating nozzle;
b) further ejecting sequential angularly displaced streams of water from the second nozzle from an area of the swimming pool intermediate the first nozzle and the collection zone to convey debris transported by the streams of water from the first nozzle into the area across which the paths of the streams of water from the second nozzle flow and other debris in the paths of the streams of water from the second nozzle and in the general direction of the collection zone;
c) said step of further ejecting including the step of precluding ejection of streams of water from the second nozzle toward the first nozzle; and
d) yet further ejecting sequential angularly displaced streams of water from an incrementally rotating third nozzle disposed in a second area of the pool to convey debris from the second area to and in the general direction of the collection zone.

24. The method as set forth in claim 23, including the step of yet further ejecting sequential angularly displaced streams of water from an incrementally rotating fourth nozzle located intermediate the second nozzle and the collection zone for transporting debris conveyed by streams of water from the second nozzle into influence of the streams of water from the fourth nozzle and conveying other debris in the path of the streams from the fourth nozzle toward the collection zone.

25. A method for cleaning a swimming pool including at least three sets of incrementally rotating nozzles, each set having at least one nozzle for sequentially ejecting angularly displaced streams of water to transport debris under the influence of the streams of water to a collection zone proximate a drain for the pool, said method comprising the steps of:
a) transporting debris with the first set located at one end of the swimming pool to an area subjected to the streams of water from the second set;
b) further transporting debris with the second set toward the collection zone, including the step of also further transporting the debris transported by the first set that becomes subjected to the streams of water from the second set toward the collection zone;
c) limiting the second set from ejecting streams of water toward the first set to discourage transport of debris toward the first set; and
d) yet further transporting debris with the third set located at another end of the swimming pool toward the collection zone.

26. The method as set forth in claim 25 wherein the swimming pool includes a fourth set of incrementally rotating nozzles having at least one nozzle for sequentially ejecting angularly displaced streams of water to transport debris, the fourth set being located intermediate the second set and the collection zone, including the step of still further transportation debris with the fourth set toward the collection zone, and transporting toward the collection zone the debris transported by the second set that becomes subjected to the streams of water from the fourth set.

27. The method as set forth in claim 26, including the step of further limiting the fourth set from ejecting streams of water toward the second set to discourage transport of debris toward the second set.

28. The method as set forth in claim 25 wherein said step of further transporting is carried by the nozzles of the second set rotating through an arc of about 180 degrees (180°) oriented toward the collection zone.

29. The method as set forth in claim 26 wherein said steps of further transporting and still further transporting are carried out the nozzles of the second an fourth set rotating through an arc of about 180 degrees (180°) oriented toward the collection zone.

30. A method for removing debris from a swimming pool having surfaces defining a first end, a second end, side walls, a bottom, a discharge outlet between the first and second ends of the swimming pool and a plurality of incrementally rotating nozzles positioned in the bottom of the pool, a first nozzle of the plurality of nozzles being positioned in the bottom generally proximate the first end, a second nozzle of the plurality of nozzles being positioned in the bottom between the first nozzle and the discharge outlet, said method comprising the steps of:
a) discharging water from the first nozzle during a first operating cycle for discharging sequential angularly displaced streams of water in a substantially 360 degree (360°) arc to dislodge debris from pool surfaces proximate to the first end of the pool while avoiding the discharge of water from the second nozzle during such first operating cycle;
b) terminating the first operating cycle;
c) further discharging water from the second nozzle during a second operating cycle, the second operating cycle commencing after termination of the first operating cycle, for discharging sequential angularly displaced streams of water in an arc of about 180 degrees (180°) to convey debris toward the discharge outlet, while avoiding the discharge of water from the second nozzle toward the first end of the pool, and avoiding discharge of water from the first nozzle during the second operating cycle.

31. The method as set forth in claim 30, including a third nozzle of the plurality of nozzles being positioned generally proximate the second end of the pool and including the step of yet further discharging sequential angularly displaced streams of water from the third nozzle during an operating cycle to discharge water in an arc of about 180 degrees (180°) and convey debris toward the discharge outlet.

32. The method as set forth in claim 30, including third nozzles of the plurality of nozzles, at least one of the third nozzles being positioned in each of the side walls of the pool and including the step of still further discharging sequential angularly displaced streams of water from the third nozzles during an operating cycle to discharge water in an arc of about 90 degrees (90°) extending from essentially a horizontal orientation to essentially a vertical orientation to convey debris toward the discharge outlet.

33. The method as set forth in claim 32, including a fourth nozzle of the plurality of nozzles being positioned generally proximate the second end of the pool and including the step of yet further discharging sequential angularly displaced streams of water from the fourth nozzle during an operating cycle to discharge water in an arc of about 180 degrees (180°) to convey debris toward the discharge outlet.

34. The method as set forth in claim 30, including a further second nozzle of the plurality of nozzles being positioned in the bottom generally between the second nozzle and the discharge outlet and including the step of further discharging sequential angularly displaced streams of water in an arc of about 180 degrees (180°) to convey debris toward the discharge outlet while avoiding discharge of streams of water from the further second nozzle toward the first end of the pool.

35. The method as set forth in claim 34, including a third nozzle of the plurality of nozzles being positioned generally proximate the second end of the pool and including the step of yet further discharging sequential angularly displaced streams of water from the third nozzle during an operating cycle to discharge water in an arc of about 180 degrees (180°) to convey debris toward the discharge outlet.

36. The method as set forth in claim 34, including third nozzles of the plurality of nozzles, at least one of the third nozzles being positioned in each of the side walls of the pool and including the step of still further discharging sequential angularly displaced streams of water from the third nozzles during an operating cycle to discharge water in an arc of about 90 degrees (90°) extending from essentially a horizontal orientation to essentially a vertical orientation to convey debris toward the discharge outlet.

37. The method as set forth in claim 35, including fourth nozzles of the plurality of nozzles, at least one of the fourth nozzles being positioned in each of the side walls of the pool land including the step of still further discharging sequential angularly displaced streams of water from the fourth nozzles during an operating cycle to discharge water in an arc of about 90 degrees (90°) extending from essentially a horizontal orientation to essentially a vertical orientation to convey debris toward the discharge outlet.

38. In a swimming pool having first and second ends, opposed side walls, a bottom surface and a collection zone proximate an outlet, the improvement comprising in combination:
a) a first incrementally rotating nozzle disposed in the bottom surface for discharging sequential angularly displaced bursts of water through an arc of about 180 degrees (180°) generally toward one side of the collection zone;
b) a second incrementally rotating nozzle disposed proximate the first end for discharging sequential angularly displaced bursts of water through an arc of about 180 degrees (180°) generally toward said first nozzle;
c) a third incrementally rotating nozzle disposed proximate the second end for discharging sequential angularly displaced bursts of water through an arc of about 180 degrees (180°) generally toward an other side of the collection zone;
d) a fourth incrementally rotating nozzle disposed in one side wall for discharging sequential angularly displaced bursts of water through an arc of about 90 degrees (90°) generally toward the second end; and
e) a fifth incrementally rotating nozzle disposed in the other side wall for discharging sequential angularly displaced bursts of water through an arc of about 90 degrees (90°) generally toward the second end.

39. A swimming pool as set forth in claim 38 including a sixth incrementally rotating nozzle disposed in the first end for discharging sequential angularly displaced bursts of water through an arc of about 360 degrees (360°) generally toward the bottom surface and the side walls.

40. A swimming pool as set forth in claim 39 including a seventh incrementally rotating nozzle disposed in the second end for discharging sequential angularly displaced bursts of water through an arc of about 180 degrees (180°) generally toward the bottom surface and the side walls.
